(19) United States
(12) Patent Application Publication
(10) Pub. No.: US 2025/0378516 A1
(43) Pub. Date: Dec. 11, 2025

(54) MACHINE LEARNING-BASED TECHNIQUES FOR PREDICTING SIMILARITY OF GOODS OR SERVICES

(71) Applicant: Camelot UK Bidco Limited, London (GB)

(72) Inventors: Peter KEYNGNAERT, Deinze (BE); Ann SMET, Stekene (BE); Jan WAERNIERS, Aalter (BE); Akanksha MISHRA, Miami, FL (US); Christina PAPAGIANNOPOULOU, Auderghem (BE); David MARQUES, Alcochete (PT); Ioannis BEKOULIS, Auderghem (BE); Amrapali PEDNEKAR, Etterbeek (BE); Marwan BELLOUTI, Ittre (BE); Vaclav DRAHOS, Pardubice (CZ)

(21) Appl. No.: 19/307,635

(22) Filed: Aug. 22, 2025

Related U.S. Application Data
(63) Continuation-in-part of application No. PCT/US2023/063264, filed on Feb. 24, 2023.

(51) Int. Cl. G06Q 50/18; G06F 40/30

(52) U.S. Cl. CPC G06Q 50/184; G06F 40/30

(57) ABSTRACT

Systems and methods are described for determining a similarity between a first goods and services description and a second goods and services description. The goods and services descriptions are provided to a machine learning model. The machine learning model returns a first set of goods and services classifications for the first goods and services description and a second set of goods and services classifications for the second goods and services description. A plurality of goods and services similarity scores are determined, each goods and services similarity score indicating a similarity between a first goods and services classification from the first set of goods and services classifications and a second goods and services classification from the second set of goods and services classifications. An aggregate goods and services similarity score is determined based on the plurality of goods and services similarity scores and returned to a user as a query result.

### CROSS-REFERENCE TO RELATED APPLICATIONS

This application is a continuation-in-part of international application PCT/US2023/063264, entitled “MACHINE LEARNING-BASED TECHNIQUES FOR PREDICTING SIMILARITY OF GOODS OR SERVICES,” and filed on Feb. 24, 2023, now pending, the entirety of which is incorporated herein by reference.

### BACKGROUND

A trademark serves to indicate the source of goods or services. A trademark may comprise words and/or designs used in connection with the sale of such goods or services. When registering a trademark, the registrant provides a classification of the trademark as well as a description of the goods or services represented to the trademark. A registered trademark serves to exclude others from using trademarks likely to confuse consumers as to the source of a good or service. A likelihood of confusion is determined based on the similarity between the trademarks and the similarity between the goods and/or services associated with the trademarks.

A user may wish to assess whether a particular trademark is likely to be determined by an administrative agency or judicial body to have a likelihood of confusion with another trademark. Such an undertaking can be extremely laborious, time-consuming, and unreliable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are described herein for determining similarities between a first and second goods and services descriptions. A user submits a query including the first and second goods and services descriptions. A machine learning model determines a first set of goods and services classifications for the first goods and services description and a second set of goods and services classifications for the second goods and services description. The system determines a plurality of goods and services similarity scores based on the first and second sets of goods and services classifications. Each goods and services similarity score indicates a level of similarity between a first goods and services classification from the first set and a second goods and services classification from the second set. An aggregate goods and services similarity score is determined based on the determined goods and services similarity scores. The aggregate goods and services similarity score is returned to the user as a query result.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present application and, together with the description, further serve to explain the principles of the embodiments and to enable a person skilled in the pertinent art to make and use the embodiments. Dashed portions of the drawings may represent optional steps and/or elements.

FIG. 1 shows a block diagram of an example system for determining similarities between goods and services descriptions, in accordance with an embodiment.

FIG. 2 depicts a flowchart of a method for determining similarities between goods and services descriptions, in accordance with an embodiment.

FIG. 3 shows a block diagram of an example system for classification of a goods and services description, in accordance with an embodiment.

FIGS. 4A-4C depict flowcharts of methods for classification of a goods and services description, in accordance with embodiments.

FIGS. 5A and 5B show block diagrams of example systems for determining goods and services classification similarity scores, in accordance with embodiments.

FIGS. 6A-6C depict flowcharts of methods for determining goods and services classification similarity scores, in accordance with embodiments.

FIG. 7 shows an example user interface (UI) element through which a user may query the similarity between two goods and services descriptions, in accordance with an embodiment.

FIG. 8 depicts a flowchart of a method for automatically initiating a trademark proceeding based on an aggregate goods and services similarity score, in accordance with an embodiment.

FIG. 9 depicts a flowchart of a method for automatically initiating the filing of a trademark application based on an aggregate goods and services similarity score, in accordance with an embodiment.

FIG. 10 shows a block diagram of an example computer system, in which embodiments may be implemented.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

As used herein, the term “trademark” is intended to encompass any symbol, logo, image, word, or words legally registered, established by use, or asserted as representing a company, product or service. The word “trademark” also encompasses service marks.

As used herein, the term “goods and services” is to be interpreted as equivalent to the terms “goods and/or services” and “goods or services.”

As used herein, the terms “goods and services classification” and/or “goods and services sub-classification” are intended to encompass any categorization of goods and services, including, but not limited to, the International Classification of Goods and Services, also known as the Nice Classification (NCL) classifications, specified by the World Intellectual Property Organization (WIPO).

The example embodiments described herein are provided for illustrative purposes and are not limiting. The examples described herein may be adapted to any type of method or system for obtaining evidence of online commercial use of trademark. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section may be combined with any other embodiments described in the same section and/or a different section.

### II. Example Embodiments

As mentioned in the Background Section, a trademark serves to indicate the source of goods or services and may comprise words and/or designs used in connection with the sale of such goods or services. A user may wish to assess whether a particular trademark is likely to be determined by an administrative agency or judicial body to have a likelihood of confusion with another trademark. For example, the user may wish to make such an assessment to help determine if an application to register the particular trademark will be accepted or refused in view of the other trademark, to help determine if filing an opposition to the registration of the particular trademark based on the other trademark will succeed or fail, and/or to help determine if use of the particular trademark will be determined to be infringing or non-infringing with respect to the use of the other trademark.

A technique for making such an assessment involves manually searching for published trademark cases (e.g., administrative agency decisions and/or judicial decisions) to find cases in which a trademark pair being adjudicated is similar to the trademark pair being investigated, reading the text of those trademark cases to see what the outcome was in each case, and then trying to infer from the outcomes of the trademark cases what the likely outcome would be for the trademark pair being investigated. Such an undertaking can be extremely laborious, time-consuming, and unreliable. Trademark registrations and laws vary greatly depending on geographical regions and jurisdiction. The number and size of trademark data sources also pose a considerable hurdle to the trademark owner. Moreover, the trademark portfolios of competing entities change over time as new trademarks are registered and unused trademarks are cancelled.

The embodiments described herein are directed to techniques for determining the similarity between a pair of goods and services descriptions. For instance, a user may submit a query including the first and second goods and services descriptions to determine the similarity between the first and second goods and services. A machine learning model determines a first set of goods and services classifications for the first goods and services description and a second goods and services description for the second goods and services description. The system determines a plurality of goods and services similarity scores based on the first and second sets. Each of the goods and services similarity scores indicate a similarity between a first goods and services classification from the first set and a second goods and services classification from the second set. The system determines an aggregate goods and services similarity score based on the determined goods and services similarity scores. The aggregate goods and services similarity score is returned to the user as a query result.

The embodiments described provide advantages, including enabling a user to assess the risk of similarity (and therefore, the risk of refusal) if a certain trademark is applied for, assess the potential success of filing an opposition, assess the potential success of a trademark infringement lawsuit, etc. For instance, given a pair of goods and services descriptions, the techniques described herein identify pairs of relevant goods and services classifications. In embodiments, the goods and services classifications are used to determine relevant historical trademark cases pertaining to the determined pairs of goods and services classifications. Based on the decisions or outcomes of the historical trademark cases, a prediction is made of the likelihood that an adjudicator would find a likelihood of confusion between trademarks from the given pair of goods and services descriptions. In other embodiments, the pairs of relevant goods and services classifications are provided to a prediction model that is trained using data from historical trademark cases. The prediction model generates a prediction indicative of the likelihood that an adjudicator would find a likelihood of similarity between the given pair of goods and services descriptions.

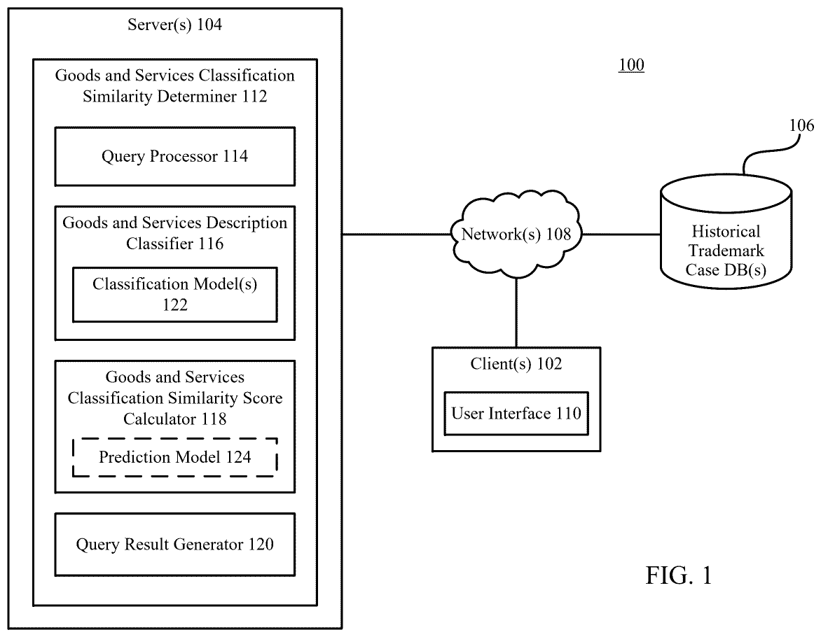

Embodiments may be configured in various ways in various environments. For instance, FIG. 1 shows a block diagram of system 100 for determining the similarities between two or more goods and services descriptions. System 100 may include one or more clients 102, one or more servers 104, and one or more historical trademark case databases 106 connected by one or more networks 108. Client(s) 102 may interact with the server(s) 104 via a user interface (UI) 110 over networks(s) 108. Furthermore, each server 104 includes a goods and services classification similarity determiner 112. Goods and services classification similarity determiner 112 includes a query processor 114, a goods and services description classifier 116, a goods and services classification similarity score calculator 118, and a query result generator 120. Goods and services description classifier 116 includes one or more classification models 122. Goods and services classification similarity score calculator 118 may, optionally include a prediction model 124. Each of the components of system 100 are described in detail as follows.

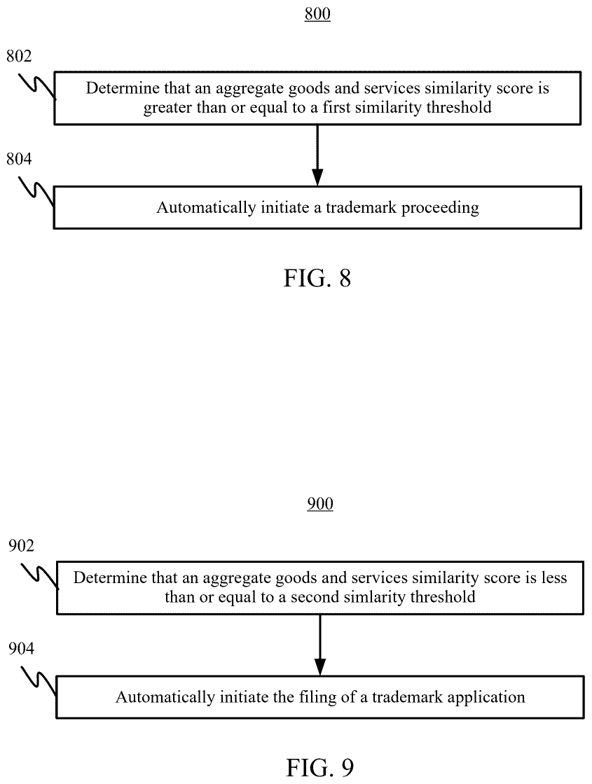

Client 102 includes any computing device suitable for performing functions that are ascribed thereto in the following description, as will be appreciated by persons skilled in the relevant art(s), including those mentioned elsewhere herein or otherwise known. Various example implementations of client 102 are described below in reference to computing device 802 of FIG. 8. Client 102 is communicatively connected to server(s) 104 through network(s) 108. Although only a single client 102 is shown in FIG. 1 for the sake of illustration, it is to be understood that system 100 may include any number of clients, each of which is capable of communicating with server(s) 104 to invoke and/or perform functions relating to determining trademark portfolio similarities as will be described herein.

Server(s) 104 may include one or more of any server computing device suitable for performing functions that are ascribed thereto in the following description, as will be appreciated by persons skilled in the relevant art(s), including those mentioned elsewhere herein or otherwise known. Server(s) 104 may be implemented separately, or with reference to the exemplary computing environment 800 of FIG. 8 described below, server(s) 104 may alternatively be implemented as on-premises servers 892, and/or as part of network-based server infrastructure 870.

Historical trademark case database(s) 106 include any database containing information regarding historical trademark cases. Historical trademark case database(s) 106 comprise a repository of information about historical trademark cases stored in an organized manner in non-volatile memory across one or more storage components or devices. Historical trademark case database(s) 106 may comprise a privately managed database of historical trademark case information that includes historical trademark case information compiled from one or more trademark jurisdictions (e.g., legal proceedings from different states, countries, regions, etc.). Examples of historical trademark cases include, but are not limited to, judicial opinions (or legal proceedings) pertaining to whether there is a likelihood of confusion between at least two trademarks (i.e., due to similarities therebetween), trademark opposition proceedings, trademark cancellation proceedings, trademark refusal proceedings, and/or any legal proceeding in which an opinion or decision regarding the similarity between one or more trademark pairs, among others, are included. The opinion or decision may be rendered by an adjudicator, such as, a judge, an administrative board or tribunal, a commission, etc. Alternatively, historical trademark case database(s) 106 may comprise a publicly available database of historical trademark case information maintained and updated, e.g., by a trademark office associated with a particular country, region, or organization. Historical trademark case database(s) 106 may comprise information about registered historical trademark cases, including the trademarks at issue, the outcome of the case, etc. For a given trademark at issue, historical trademark case database(s) 106 may store information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark.

Network(s) 108 includes any one or more networks suitable for interconnecting and enabling the communication of data between computing devices. For instance, network(s) 108 may comprise one or more networks such as local area networks (LANs), wide area networks (WANs), enterprise networks, the Internet, etc., and may include one or more wired and/or wireless portions.

In the example implementation depicted in FIG. 1, system 100 comprises a “front-end” component comprising at least UI 110 that executes on client(s) 102, as well as a number of “back-end” components that execute on server(s) 104. Client(s) 102 are communicatively connected to server(s) 104 (e.g., via network(s) 108 or some other network(s) or peer-to-peer connection), such that these components may interact with each other. However, this is only one example implementation. In an alternate implementation, the components of the application may execute on a single computing device. In a further alternate implementation, the distribution of components between client(s) 102 and server(s) 104 may be different than that shown in FIG. 1.

UI 110 executing on client(s) 102 is an interface by which a user interacts with the goods and services classification similarity determiner 112. UI 110 may operate to accept input to the application from a user and to present outputs of goods and services classification similarity determiner 112 to the user. UI 110 may comprise one or more of a graphical UI (GUI), a touchscreen GUI, a menu-driven interface, a command line interface, a voice UI, a conversational UI, or the like, including further or alternative user interface elements mentioned elsewhere herein. In certain embodiments, UI 110 be presented to the user via a browser executing on client(s) 102.

As shown in FIG. 1, the “back-end” components of the application implemented on server(s) 104 include goods and services classification similarity determiner 112, query processor 114, goods and services description classifier 116, goods and services classification similarity score calculator 118, query result generator 120, classification model(s) 122 and prediction model 124, and the components depicted therein.

Goods and services classification similarity determiner 112 is configured to receive a user query including a first and a second goods and services descriptions, and, optionally, a main classification for either or both of the goods and services descriptions. Goods and services classification similarity determiner 112 may be further configured to return to the user an indication of the degree of similarity between the goods and services descriptions.

Query processor 114 is configured to receive the user query and provide the query to other components of goods and services classification similarity determiner 112. For example, query processor 114 may parse the user query to extract the first and the second goods and services descriptions and the main classifications, if any, associated therewith. Query processor 114 may then provide the extracted goods and services descriptions and the main classifications, if any, associated therewith to goods and services description classifier 116.

Goods and services description classifier 116 is configured to receive goods and services descriptions and determine the main classification and/or the sub-classifications that are most likely to be associated with the goods and services descriptions. In embodiments, goods and services description classifier 116 may employ classification model(s) 122 to determine such main classification and/or sub-classifications. Classification model(s) 122 may include one or more machine learning models that are trained using existing trademark information, including goods and services descriptions and corresponding main classifications and/or sub-classifications. Classification model(s) 122 may receive a goods and services description as input and provide a goods and services classification and a confidence probability as output. In embodiments, the goods and services may be pre-processed (e.g., tokenized) prior to being provided to classification model(s) 122. In embodiments, the confidence probability may have various forms, such as having two values (e.g., 0 for low confidence, 1 for high confidence), or having a range of values, such as being a numerical value between 0.0 and 1.0, with 0.0 indicating low confidence in the goods and services classification and 1.0 indicating high confidence in the goods and services classification. In embodiments, classification model(s) 122 may be applied to token(s) 312 and/or the set of text fragments 314 one at a time until a classification model produces a goods and services classification with a corresponding confidence probability that satisfies a predetermined relationship with a threshold (e.g., >0.99). For example, if a first classification model generates a goods and services classification with a confidence probability of 0.997, other classification models may be skipped.

In embodiments, goods and services description classifier 116 may process the output from classification model(s) 122 to produce a first set of goods and services classifications for the first goods and services description and a second set of goods and services classifications for the second goods and services classifications. In embodiments, goods and services description classifier 116 may rank and/or filter the results from classification model(s) 122 in order to reduce the number of goods and services classifications to consider by goods and services classification similarity score calculator 118. For example, goods and services description classifier 116 may limit each set of goods and services classifications to sub-classifications of a particular main classification. This may be performed based on main classification(s) provided in the query by the user and/or based on a determination of the main classification by goods and services description classifier 116 based on the goods and services descriptions. Goods and services description classifier 116 may also, or alternatively, limit the number of classifications in each set of goods and services classifications. By limiting the number of classifications under consideration, the amount of processing performed by goods and services classification similarity score calculator 118 may be reduced. Goods and services description classifier 116 may provide the first and second sets of goods and services classifications to goods and services classification similarity score calculator 118.

In embodiments, classification model(s) 122 may include, but are not limited to, machine learning-based classification models that are generated by fine-tuning publicly available pre-trained natural language processing (NLP) models (e.g., Bidirectional Encoder Representations from Transformers (BERT), Generative Pretrained Transformer (GPT), Embeddings from Language Models (ELMo), Transformer-XL, XLNet, Robustly Optimized BERT (ROBERTa), etc.). Pre-trained NLP models may be trained using a large corpus of textual data (e.g., Wikipedia, IMDB, etc.) to classify text. In embodiments, pre-trained NLP models may tokenize text into one or more words or word fragments and generate word, sentence, and/or position embeddings (e.g., using smooth inverse frequency (SIF), BERT, word2vec, etc.) that are vector representations of the tokenized words or word fragments. In embodiments, the pre-trained NLP models may classify text based on the similarity (e.g., cosine distance/similarity, Euclidean distance, etc.) between the embedding vectors.

A pre-trained NLP model may be fine-tuned to perform goods and services classification by retraining the model using labeled datasets that include sample text along with a corresponding goods and services classification (e.g., [‘43’, ‘tea shops’]). The datasets may include a training dataset, a test dataset and/or a validation dataset. Each dataset may include a plurality of text samples for each of the goods and services classifications. In embodiments, the datasets may be generated by manually labeling text samples with goods and services categories. However, the dataset may also be automatically or semi-automatically generated based on available data, for example, by correlating existing trademark classification data from public databases with descriptions of the goods or services associated with the trademark.

Fine-tuning of pre-trained NLP models may further include adjusting one or more hyperparameters of the pre-trained NLP model (e.g., learning rate, number of layers, etc.), defining the loss function used to retrain the pre-trained NLP model (e.g., multi-class cross entropy error, mean squared error, etc.), and/or adding one or more layers to the pre-trained NLP model. Pre-trained NLP models may be fine-tuned by iteratively training the model using the training dataset and evaluating the trained model using the test dataset and the loss function until the loss converges. In embodiments, the trained model may further be validated using the validation dataset in order to avoid overfitting or underfitting. In embodiments, a plurality of classification models may be trained, for example, using different pre-trained models and/or different hyperparameters. The plurality of trained classification models may be evaluated based on classification metrics (e.g., accuracy, precision, recall, etc.) calculated based on the number of true positives, true negatives, false positives, and/or false negatives generated by each model. In embodiments, classification model(s) 122 may include the best performing models generated by this process.

Goods and services classification similarity score calculator 118 is configured to receive the first and second sets of goods and services classifications from goods and services description classifier 116. Goods and services classification similarity score calculator 118 may determine one or more goods and services similarity scores based on the goods and services classifications from the first and the second sets of goods and services classifications. Various methods of calculating a goods and services similarity score between a first goods and services classification and a second goods and services classification are disclosed herein. In embodiments, a goods and services similarity score may include the percentage of historical trademark cases where a similarity assessment has determined that the first goods and services classification is similar to the second goods and services classification. In embodiments, a goods and services similarity score may be determined by prediction model 124 that is trained using the historical trademark cases.

In embodiments, prediction model 124 may be generated by a model trainer. The model trainer may be configured to train and generate prediction model 124 as any suitable type of machine learning model, including a CNN (Convolutional Neural Network) using 1D or other dimension of convolution layers, a long short-term memory (LSTM) network, one or more transformers, etc. For example, the model trainer may receive a dataset including pairs of goods and services classifications and a label (e.g., 0 or 1) indicating whether the pair of goods and services classifications are similar. The dataset includes a proportion of pairs of goods and services classifications that are labeled as similar (i.e., 1) and a proportion of pairs of goods and services classifications that are labeled as not similar (e.g., 0). The dataset may be automatically or manually generated based on information from historical trademark cases, for example, data stored historical trademark case database(s) 106. For example, historical trademark cases may be analyzed, either manually or automatically, to determine whether each historical trademark case included a similarity assessment, the goods and services classifications of the trademarks involved in the similarity assessment, and the outcome of the similarity assessment. Each similarity assessment, including the pair of goods and services classifications and the outcome of the similarity assessment, may form a data point in the dataset. The dataset may be divided into a training dataset for training, a testing data set for testing and/or a validation dataset for validation.

The model trainer may iteratively train the model using the training dataset and evaluate the trained model using the testing dataset and a loss function until the loss converges. The trained model may further be validated using the validation dataset in order to avoid overfitting or underfitting. In embodiments, a plurality of prediction models may be trained, for example, using different machine learning algorithms and/or different hyperparameters (e.g., learning rate, number and/or types of layers, etc.). The plurality of trained prediction models may be evaluated based on prediction metrics (e.g., accuracy, precision, recall, etc.) calculated based on the number of true positives, true negatives, false positives, and/or false negatives generated by each model. In embodiments, prediction model 124 may include the best performing model generated by this process.

In embodiments, goods and services classification similarity score calculator 118 may calculate a goods and services similarity score for each pair of a first goods and services classification from the first set of goods and services classifications and a second goods and services classification from the second set of goods and services classifications. In embodiments, goods and services classification similarity score calculator 118 may determine an aggregate goods and services similarity score based on the one or more goods and services similarity scores. In embodiments, the aggregate goods and services similarity score may include, but is not limited to, a weighted or unweighted average, a maxima or a minima, or any other mathematical function of the one or more goods and services similarity scores. Goods and services classification similarity score calculator 118 may provide the aggregate goods and services similarity score to query result generator 120 for output to the user.

Query result generator 120 may be configured to receive the aggregate goods and services similarity score from goods and services classification similarity score calculator 118 and provide the aggregate goods and services similarity score to the user via UI 110. In embodiments, query result generator 120 may provide detailed information related to the aggregate goods and services similarity score, including, but not limited to, one or more of the goods and services similarity scores that were used to calculate the aggregate goods and services similarity score and/or the goods and services classifications that were used to calculate the one or more goods and services similarity scores.

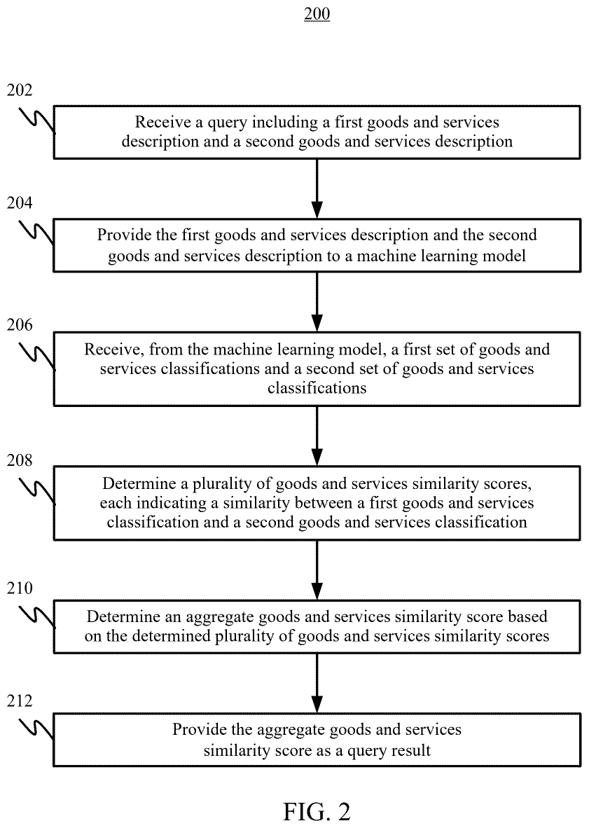

Embodiments described herein may operate in various ways to determine similarities between goods and services descriptions. For example, FIG. 2 depicts a flowchart 200 of a method for determining similarities between goods and services descriptions. In an embodiment, flowchart 200 may be implemented by system 100. Accordingly, flowchart 200 will be described with continued reference to FIG. 1. The method of flowchart 200 starts at step 202.

In step 202, a query including a first goods and services description and a second goods and services description is received. For example, query processor 114 of goods and services classification similarity determiner 112 may receive a query from client(s) 102 via UI 110 over network(s) 108. As discussed above, query processor 114 may parse the query to extract the first and second goods and services description and the main classifications, if any, associated therewith. Query processor may provide the first and second goods and services description and the main classifications, if any, associated therewith to goods and services description classifier 116.

In step 204, the first goods and services description and the second goods and services description are provided to a machine learning model. For example, goods and services description classifier 116 may receive the first and second goods and services descriptions from query processor 114 and provide the first and second goods and services descriptions to one or more of classification model(s) 122.

In step 206, a first set of goods and services classifications and a second set of goods and services classifications are received from the machine learning model. For example, goods and services description classifier 116 may receive, from each of the classification model(s) 122, a first set of goods and services classifications for the first goods and services description and a second set of goods and services classifications for the second goods and services description. Goods and services description classifier 116 may provide the first and second sets of goods and services classifications to goods and services classification similarity score calculator 118. As discussed above, goods and services description classifier 116 may rank and/or filter the results from classification model(s) 122 prior to providing the first and second sets of goods and services classifications to goods and services classification similarity score calculator 118. For example, goods and services description classifier 116 may limit each set of goods and services classifications to sub-classifications of a particular main classification, limit the number of classifications in each set of goods and services classifications, and/or filter according to another criteria.

In step 208, a plurality of goods and services similarity scores are determined, each goods and services similarity score indicating the similarity between a first goods and services classification and a second goods and services classification. For example, goods and services classification similarity score calculator 118 may receive the first and second sets of goods and services classifications from goods and services description classifier 116 and calculate a goods and services similarity score for a pair of a first goods and services classification from the first set and a second goods and services classification from the second set. In embodiments, goods and services classification similarity score calculator 118 may calculate a goods and services similarity score for each pair of a first goods and services classification from the first set of goods and services classifications and a second goods and services classification from the second set of goods and services classifications.

In step 210, an aggregate goods and services similarity score is determined based on the determined plurality of goods and services similarity scores. For example, goods and services classification similarity score calculator 118 may determine an aggregate goods and services similarity score based on one or more goods and services similarity scores. As discussed above, the aggregate goods and services similarity score may include, but is not limited to, a weighted or unweighted average, a maxima or a minima, or any other mathematical function of the one or more goods and services similarity scores. Goods and services classification similarity score calculator 118 may provide the aggregate goods and services similarity score to query result generator 120 for output to the user.

In step 212, the aggregate goods and services similarity score is provided to the user as a query result. For example, query result generator 120 may receive an aggregate goods and services similarity score from goods and services classification similarity score calculator 118 and provide the aggregate goods and services similarity score to the user via UI 110.

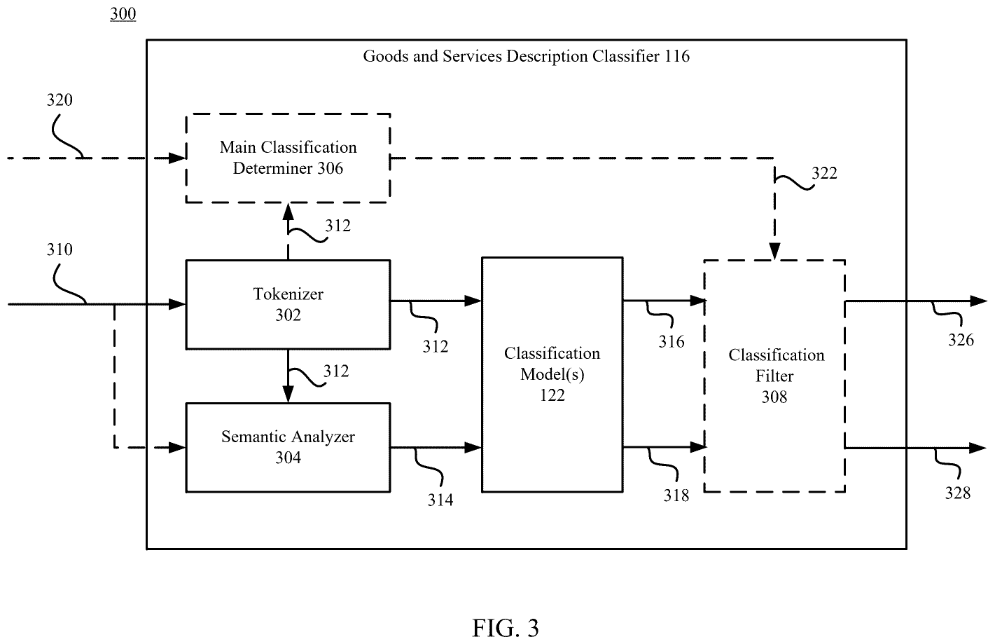

Goods and services description classifier 116 of FIG. 1 may be configured in various ways. For instance, FIG. 3 shows a block diagram of an example system 300 for classification of a goods and services description in accordance with an embodiment. As shown in FIG. 3, system 300 includes goods and services description classifier 116, as shown and described above with respect to FIG. 1. Goods and services description classifier 116 may include classification model(s) 122, as shown and described above with respect to FIG. 1, and may further include a tokenizer 302, a semantic analyzer 304, a main classification determiner 306 and/or a classification filter 308. In embodiments, main classification determiner 306 and/or classification filter 308 may be omitted from goods and services description classifier 116.

Tokenizer 302 receives a goods and services description 310 from query processor 114 and tokenizes (e.g., demarcates a string of input characters) goods and services description 310 to generate one or more tokens 312 (i.e., string with identified meanings) that each include one or more words from goods and services description 310. Tokenizer 302 may provide the token(s) 312 to one or more of semantic analyzer 304, main class determiner 306 and/or classification model(s) 122.

Sematic analyzer 304 receives token(s) 312 from tokenizer 302 and determines a set of text fragments 314 that are semantically similar to the token(s) 312. Semantic analyzer 304 may employ various methods to determine the set of text fragments 314, including, but not limited to, determining synonyms for token(s) 312, performing natural language processing of token(s) 312, determining text fragments that have high topological similarity, statistical similarity, and/or semantics-based similarity to token(s) 312, employing a machine learning model that is trained to measure the semantic similarity between textual objects, and/or other semantic analysis techniques known to those of ordinary skill in the art. Semantic analyzer may provide the set of text fragments 314 to classification model(s) 122. In embodiments, semantic analyzer 304 may, alternatively or additionally, operate directly on goods and services description 310 to determine the set of text fragments 314.

Classification model(s) 122 receives token(s) 312 and/or the set of text fragments 314 from tokenizer 302 and/or semantics analyzer 304, respectively. As discussed above, classification model(s) 122 may include one or more machine learning models that are trained using existing trademark information, including goods and services descriptions and corresponding main classifications and/or sub-classifications. In embodiments, classification model(s) 122 may be applied to token(s) 312 and/or the set of text fragments 314 to generate goods and services classifications 316 and/or 318, respectively. In embodiments, classification model(s) 122 may determine embedding vectors for token(s) 312 and/or the set of text fragments 314 and compare the embedding vectors to a database of embeddings generated from goods and services main classification descriptions and/or semantically similar text fragments. In embodiments, goods and services classifications 316 and/or 318 may correspond to the embeddings from the database that have the smallest distance (e.g., Euclidean or Cosine distance) to the embedding vectors for token(s) 312 and/or the set of text fragments 314, respectively. For example, goods and services classification 316 may include the most likely main classifications and/or sub-classifications for token(s) 312, while goods and services classification 318 may include the most likely main classifications and/or sub-classifications for the set of text fragments 314. In embodiments, goods and services classifications 316 and/or 318 may also include one or more confidence probabilities associated with the goods and services classifications.

While goods and services classifications 316 and 318 are depicted in FIG. 3 as separate outputs, in embodiments, goods and services classifications 316 and 318 may be combined into a single output. While goods and services classifications 316 and 318 are depicted in FIG. 3 as single outputs, in embodiments, classification model(s) 122 may each generate separate goods and services classifications 316 and 318, resulting in a plurality of goods and services classifications 316 and 318. Classification model(s) 122 may provide goods and services classifications 316 and/or 318 to classification filter 308. In embodiments where classification filter 308 is omitted, classifications model(s) 122 may provide goods and services classifications 316 and/or 318 directly to goods and services classification similarity score calculator 118.

Main classification determiner 306 may determine a main classification 322 for goods and services description 310. In embodiments where the query includes a main classification, query processor 114 may provide the main classification to main classification determiner 306 as input 320. In embodiments, main classification determiner 306 may, alternatively or additionally, receive token(s) 312 from tokenizer 302 and process token(s) 312 to determine main classification 322. In embodiments, main classification determiner 306 may determine main classification 322 through various ways, including, but not limited to, by determining the main classification that matches the highest number of tokens, by determining the semantic similarity between the tokens and words or descriptions associated with classifications, by employing a machine learning-based classification model, and/or any other method known to those of skill in the art. Main classification determiner 306 may provide main classification 322 to classification filter 308.

Classification filter 308 may receive goods and services classifications 316 and/or 318 from classification model(s) 122. In embodiments, classification filter 308 may also receive main classification 322 from main classification determiner 306. In embodiments, classification filter 308 may filter goods and services classifications 316 and/or 318 to determine filtered goods and services classifications 326 and/or 328, respectively. Filtering goods and services classification 316 and/or 318 may reduce the number of goods and services classification under consideration by goods and services classification similarity score calculator 118, thereby reducing computational costs and processing time. Various methods may be used to filter goods and services classifications 316 and/or 318 to determine filtered goods and services classifications 326 and/or 328, including, but not limited to, based on a comparison of the corresponding confidence probabilities to a predetermined confidence threshold, based the goods and services classifications 316 and/or 318 having the highest corresponding confidence probabilities, based on main classification 322, based on the number of times a goods and services classification appears in goods and services classifications 316 and/or 318, and/or any other filtering method known to those of skill in the art. Classification filter 308 may provide filtered goods and services classifications 326 and/or 328 to goods and services classification similarity score calculator 118.

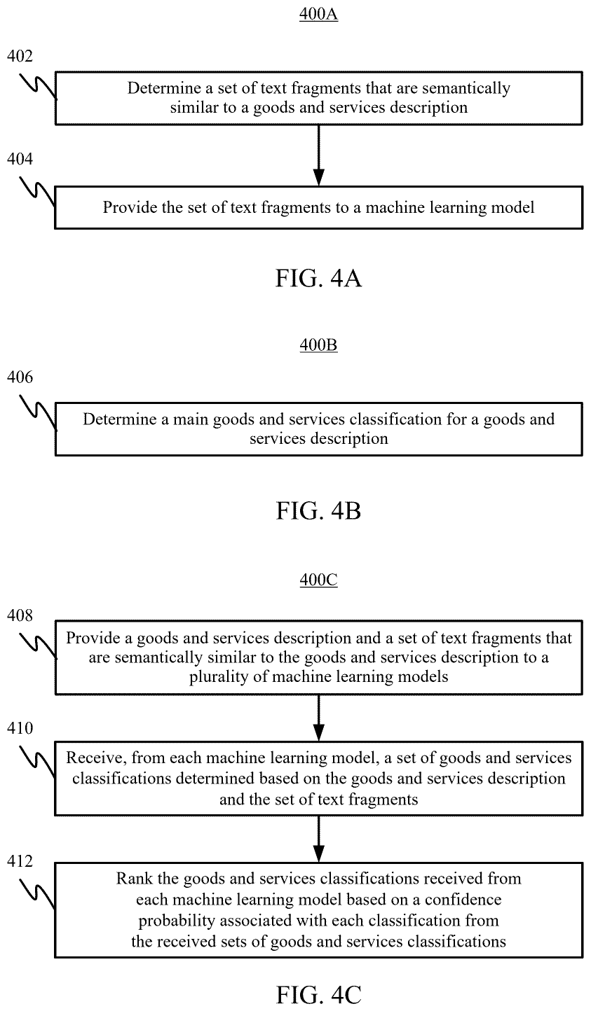

Embodiments described herein may operate in various ways to determine classifications for goods and services descriptions. FIG. 4A depicts a flowchart 400A of a method for determining text fragments that are semantically similar to goods and services descriptions for use in classification of the goods and services descriptions. In an embodiment, flowchart 400A may be implemented by systems 100 and/or 300. Accordingly, flowchart 400A will be described with continued reference to FIGS. 1 and 3. While the method of flowchart 400A is performed on a single goods and services description, systems 100 and/or 300 may perform, in parallel or in series, the method of flowchart for each of the first goods and services description and the second goods and services. The method of flowchart 400A starts at step 402.

In step 402, a set of text fragments that are semantically similar to a goods and services description is determined. For example, tokenizer 302 may receive goods and services description 310 and provide, to semantic analyzer 304, token(s) 312, that are generated based on goods and services description 310. Semantic analyzer 304 may receive token(s) 312 from tokenizer 302 and determine a set of text fragments that are semantically similar to token(s) 312. In embodiments, semantic analyzer 304 may operate directly on goods and services 310.

In step 404, the set of text fragments are provided to a machine learning model. For example, semantic analyzer 304 may provide the set of text fragments 314 to classification model(s) 122.

Embodiments described herein may operate in various ways to determine classifications for goods and services descriptions. FIG. 4B depicts a flowchart 400B of a method for determining a main goods and services classification. In an embodiment, flowchart 400B may be implemented by systems 100 and/or 300. Accordingly, flowchart 400B will be described with continued reference to FIGS. 1 and 3. While the method of flowchart 400B is performed on a single goods and services description, systems 100 and/or 300 may perform, in parallel or in series, the method of flowchart for each of the first goods and services description and the second goods and services. The method of flowchart 400B starts at 406.

In step 406, a main goods and services classification is determined for a goods and services description. For example, main classification determiner 306 may determine the main classification for goods and services description 310. As discussed above, in embodiments where the query includes a main classification, query processor 114 may provide the main classification to main classification determiner 306 as input 320. Main classification determiner 306 may, alternatively or additionally, receive token(s) 312 from tokenizer 302 and process token(s) 312 to determine main classification 322. In embodiments, main classification determiner 306 may determine main classification 322 through various ways, including, but not limited to, by determining the main classification that matches the highest number of tokens, by determining the semantic similarity between the tokens and words or descriptions associated with classifications, by employing a machine learning-based classification model, and/or any other method known to those of skill in the art. Main classification determiner 306 may provide main classification 322 to classification filter 308.

Embodiments described herein may operate in various ways to determine classifications for goods and services descriptions. FIG. 4C depicts a flowchart 400C of a method for determining a main goods and services classification. In an embodiment, flowchart 400C may be implemented by systems 100 and/or 300. Accordingly, flowchart 400C will be described with continued reference to FIGS. 1 and 3. While the method of flowchart 400C is performed on a single goods and services description, systems 100 and/or 300 may perform, in parallel or in series, the method of flowchart for each of the first goods and services description and the second goods and services. The method of flowchart 400C starts at 408.

In step 408, a goods and services description and a set of text fragments that are semantically similar to the goods and services description are provided to a plurality of machine learning models. For example, tokenizer 302 may determine token(s) 312 based on goods and services description 310 and provide token(s) 312 to classification model(s) 122 and semantic analyzer 304. Semantic analyzer 304 may determine the set of text fragments 314 that are semantically similar to token(s) 312 and provide the set of text fragments 314 to classification model(s) 122. As discussed above, semantic analyzer 304 may employ various methods to determine the set of text fragments 314, including, but not limited to, determining synonyms for token(s) 312, performing natural language processing of token(s) 312, determining text fragments that have high topological similarity, statistical similarity, and/or semantics-based similarity to token(s) 312, employing a machine learning model that is trained to measure the semantic similarity between textual objects, and/or other semantic analysis techniques known to those of ordinary skill in the art. In embodiments, semantic analyzer 304 may, alternatively or additionally, operate directly on goods and services description 310 to determine the set of text fragments 314.

In step 410, a set of goods and services classifications determined based on the goods and services description and the set of text fragments are received from each machine learning model. For example, classification model(s) 122 may each be applied to token(s) 312 and/or the set of text fragments 314 to determine goods and services classifications 316 and/or 318, respectively. As discussed above, classification model(s) 122 may determine embedding vectors for token(s) 312 and/or the set of text fragments 314 and compare the embedding vectors to a database of embeddings generated from goods and services main classification descriptions and/or semantically similar text fragments. In embodiments, goods and services classifications 316 and/or 318 may correspond to the embeddings from the database that have the smallest distance (e.g., Euclidean or Cosine distance) to the embedding vectors for token(s) 312 and/or the set of text fragments 314, respectively. For example, goods and services classification 316 may include the most likely main classifications and/or sub-classifications for token(s) 312, while goods and services classification 318 may include the most likely main classifications and/or sub-classifications for the set of text fragments 314. In embodiments, goods and services classifications 316 and/or 318 may also include one or more confidence probabilities associated with the goods and services classifications. As discussed above, in embodiments, classification model(s) 122 may be applied to token(s) 312 and/or the set of text fragments 314 one at a time until a classification model produces a goods and services classification with a corresponding confidence probability that satisfies a predetermined relationship with a threshold (e.g., >0.99). For example, if a first classification model generates a goods and services classification with a confidence probability of 0.997, other classification models may be skipped.

In step 412, the goods and services classifications received from each machine learning model may be ranked based on a confidence probability associated with each classification from the received sets of goods and services classifications. For example, classification filter 308 may rank goods and services classifications 316 and/or 318 based on the confidence probabilities associated with each of the goods and services classifications. In embodiments, classification filter 308 may filter goods and services classifications 316 and/or 318 to determine filtered goods and services classifications 326 and/or 328, respectively. In embodiments, filtered goods and services classifications 326 and/or 328 may include the goods and services classification having the highest confidence probability that meets a predetermined threshold in goods and services classifications 316 and/or 318, respectively. If no goods and services classification of goods and services classifications 316 and/or 318 have a confidence probability that meets the predetermined threshold, filtered goods and services classifications 326 and 328 may include the goods and services classifications that appear the highest number of times in goods and services classifications 316 and/or 318, respectively. Classification filter 308 may provide filtered goods and services classifications 326 and/or 328 to goods and services classification similarity score calculator 118.

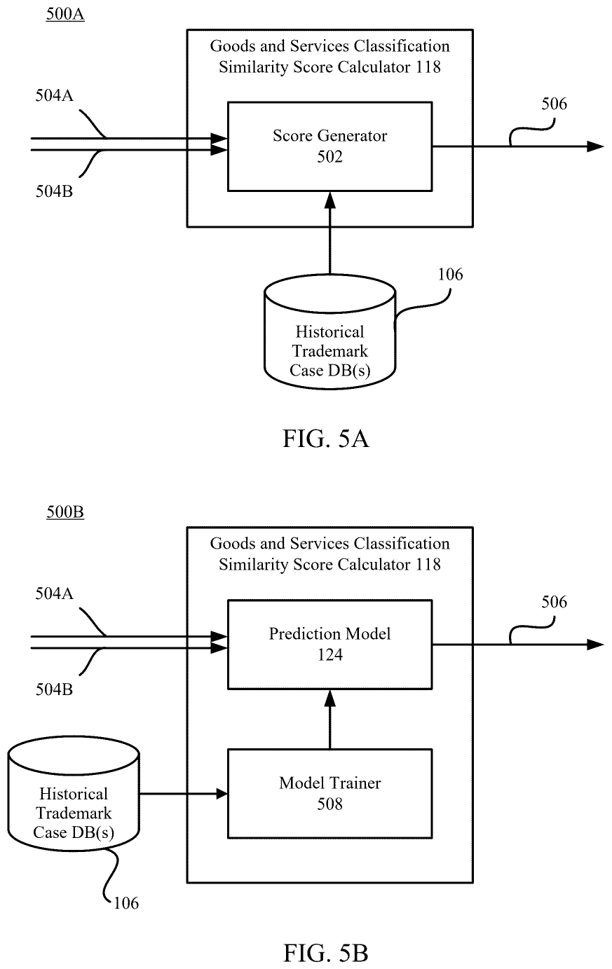

Goods and services classification similarity score calculator 118 of FIG. 1 may be configured in various ways. For instance, FIG. 5A shows a block diagram of an example system 500A for determining a goods and services classification similarity score in accordance with an embodiment. As shown in FIG. 5A, system 500A includes goods and services classification similarity score calculator 118 and historical trademark case database(s) 106, as shown and described above in relation to FIG. 1. As shown in FIG. 5A, goods and services classification similarity score calculator 118 may further include a score generator 502.

Score generator 502 may receive from goods and services description classifier 116, a first set of goods and services classifications 504A determined based on the first goods and services description and a second set of goods and services classifications 504B determined based on the second goods and services description. In embodiments, the first set of goods and services classifications 504A may include filtered goods and services classifications 326 and/or 328 that are determined by goods and services description classifier 116 based on the first goods and services description, while the second set of goods and services classifications 504B may include filtered goods and services classifications 326 and/or 328 that are determined by goods and services description classifier 116 based on the second goods and services description. For one or more pairs of a first goods and services classification from the first set of goods and services classifications 504A and a second goods and services classification from the second set of goods and services classifications 504B, score generator 504 determines a goods and services similarity score 506 that is indicative of the similarity between the first goods and services classification from the first set of goods and services classifications 504A and the second goods and services classification from the second set of goods and services classifications 504B. In embodiments, score generator 502 may access historical trademark case database(s) 106 to determine relevant historical trademark cases where a similarity assessment was made between the first goods and services classification from the first set of goods and services classifications 504A and the second goods and services classification from the second set of goods and services classifications 504B. Score generator 502 may analyze the relevant historical trademark cases to determine goods and services similarity score 506. Score generator 502 may determine goods and services similarity score 506 using various methods, including, but not limited to, based on the proportion of the relevant historical trademark cases where the similarity assessment determined that the first goods and services from the first set of goods and services classifications 504A is similar to the second goods and services classification from the second set of goods and services classifications 504B. In embodiments, score generator 502 may provide, to query result generator 120, a plurality of goods and services similarity scores 506, each goods and services similarity score 506 corresponding to a different pair of the one or more pairs of a first goods and services classification from the first set of goods and services classifications 504A and a second goods and services classification from the second set of goods and services classifications 504B. In embodiments, score generator 502 may also provide to query result generator 120 identification of the pair of the first goods and services classification from the first set of goods and services classifications 504A and the second goods and services classification from the second set of goods and services classifications 504B that correspond to each goods and services similarity score 506. In embodiments, score generator 502 may, additionally or alternatively, aggregate the plurality of goods and services similarity scores 506 to determine an aggregate goods and services similarity score and provide the aggregate goods and services similarity score to query result generator 120.

Alternatively, goods and services classification similarity score calculator 118 of FIG. 1 may be configured in other ways. For instance, FIG. 5B shows a block diagram of an example system 500B for determining a goods and services classification similarity score in accordance with an embodiment. As shown in FIG. 5B, system 500B includes goods and services classification similarity score calculator 118, historical trademark case database(s) 106, and prediction model 124, as shown and described above in relation to FIG. 1. As shown in FIG. 5B, goods and services classification similarity score calculator 118 may further include a model trainer 508.

In embodiments, prediction model 124 may be used in lieu of score generator 502 to determine the plurality of goods and services similarity scores 506 and/or the aggregate goods and services similarity score. In embodiments, prediction model 124 is generated by model trainer 508 based on a supervised machine learning algorithm using one or more datasets, including, but not limited to, a subset or all of the information from historical trademark case database(s) 106. As discussed above, model trainer 508 may be configured to train and generate prediction model 124 as any suitable type of machine learning model, including a CNN using 1D or other dimension of convolution layers, a long short-term memory (LSTM) network, one or more transformers, etc. For example, the model trainer may receive a dataset including pairs of goods and services classifications and a label (e.g., 0 or 1) indicating whether the pair of goods and services classifications are similar. The dataset may be divided into a training dataset for training, a testing data set for testing and/or a validation dataset for validation. Model trainer 508 may iteratively train the model using the training dataset and evaluate the trained model using the testing dataset and a loss function until the loss converges. The trained model may further be validated using the validation dataset in order to avoid overfitting or underfitting. In embodiments, a plurality of prediction models may be trained, for example, using different machine learning algorithms and/or different hyperparameters (e.g., learning rate, number and/or types of layers, etc.), and the highest performing trained model may be selected as prediction model 124. In embodiments, prediction model 124 may be updated or retrained as new trademark case information becomes available.

As discussed above, the datasets may be automatically or manually generated based on information from historical trademark cases, for example, data stored historical trademark case database(s) 106. For example, historical trademark cases may be analyzed, either manually or automatically, to determine whether each historical trademark case included a similarity assessment, the goods and services classifications of the trademarks involved in the similarity assessment, and the outcome of the similarity assessment. Each similarity assessment, including the pair of goods and services classifications and the outcome of the similarity assessment, may form a data point in the dataset.

In embodiments, prediction model 124 may receive from goods and services description classifier 116 a first set of goods and services classifications 504A determined based on the first goods and services description and a second set of goods and services classifications 504B determined based on the second goods and services description. In embodiments, the first set of goods and services classifications 504A may include filtered goods and services classifications 326 and/or 328 that are determined by goods and services description classifier 116 based on the first goods and services description, while the second set of goods and services classifications 504B may include filtered goods and services classifications 326 and/or 328 that are determined by goods and services description classifier 116 based on the second goods and services description. For one or more pairs of a first goods and services classification from the first set of goods and services classifications 504A and a second goods and services classification from the second set of goods and services classifications 504B, prediction model 124 may output a similarity score that predicts the similarity between the first goods and services classification and the second goods and services classification. In embodiments, the similarity score may be a numerical value between 0% and 100%, with 0% indicating no similarity and 100% indicating a high degree of similarity.

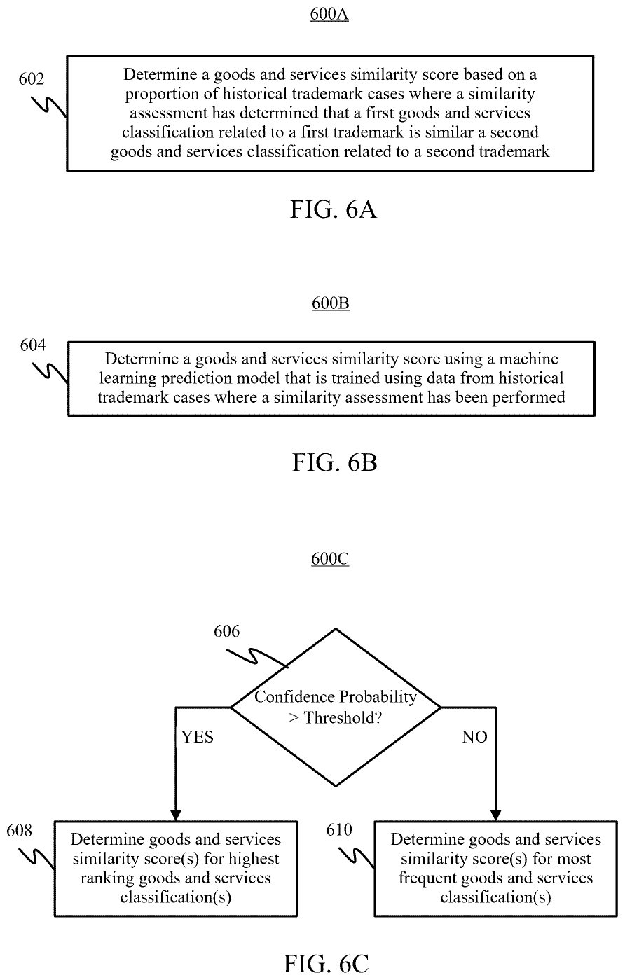

Embodiments described herein may operate in various ways to determine goods and services similarity scores. FIG. 6A depicts a flowchart 600A of a method for determining a goods and services similarity score. In an embodiment, flowchart 600A may be implemented by systems 100, 500A and/or 500B. Accordingly, flowchart 600A will be described with continued reference to FIGS. 1 and 5. The method of flowchart 600A starts at 602.

In step 602, a goods and services similarity score is determined based on a proportion of historical trademark cases where a similarity assessment has determined that determined that a first goods and services classification related to a first trademark is similar a second goods and services classification related to a second trademark. For example, score generator 502 may determine goods and services similarity score 506 based on the proportion of the relevant historical trademark cases where the similarity assessment determined that the first goods and services from the first set of goods and services classifications 504A is similar to the second goods and services classification from the second set of goods and services classifications 504B. As discussed above, score generator 502 may access historical trademark case database(s) 106 to determine relevant historical trademark cases where a similarity assessment was made between the first goods and services classification from the first set of goods and services classifications 504A and the second goods and services classification from the second set of goods and services classifications 504B. Score generator 502 may analyze the relevant historical trademark cases to determine goods and services similarity score 506.

Embodiments described herein may operate in various ways to determine goods and services similarity scores. FIG. 6B depicts a flowchart 600B of a method for determining a goods and services similarity score. In an embodiment, flowchart 600B may be implemented by systems 100, 500A and/or 500B. Accordingly, flowchart 600B will be described with continued reference to FIGS. 1 and 5. The method of flowchart 600B starts at 604.

In step 604, a goods and services similarity score is determined using a machine learning prediction model that is trained using data from historical trademark cases where a similarity assessment has been performed. For example, prediction model 124 may be used to determine goods and services similarity score 506. As discussed above, prediction model 124 may receive from goods and services description classifier 116, a first set of goods and services classifications 504A determined based on the first goods and services description and a second set of goods and services classifications 504B determined based on the second goods and services description. In embodiments, the first set of goods and services classifications 504A may include filtered goods and services classifications 326 and/or 328 that are determined by goods and services description classifier 116 based on the first goods and services description, while the second set of goods and services classifications 504B may include filtered goods and services classifications 326 and/or 328 that are determined by goods and services description classifier 116 based on the second goods and services description. For one or more pairs of a first goods and services classification from the first set of goods and services classifications 504A and a second goods and services classification from the second set of goods and services classifications 504B, prediction model 124 may predict the similarity between the first goods and services classification and the second goods and services classification.

Embodiments described herein may operate in various ways to determine goods and services similarity scores. FIG. 6C depicts a flowchart 600C of a method for determining a goods and services similarity score. In an embodiment, flowchart 600C may be implemented by systems 100, 500A and/or 500B. Accordingly, flowchart 600C will be described with continued reference to FIGS. 1 and 5. The method of flowchart 600C starts at 606.

In step 606, a confidence probability for a goods and services classification is compared to a threshold. For example, score generator 502 may determine whether confidence probabilities associated with goods and services classifications in the first set of goods and services classifications 504A and/or the second set of goods and services classifications 504B satisfy a predetermined condition with a predetermined threshold. If it is determined that at least some of the confidence probabilities in the first set of goods and services classifications 504A and/or the second set of goods and services classifications 504B satisfy the predetermined condition with the predetermined threshold, the method of flowchart 600C proceeds to step 608. If it is determined that none of the confidence probabilities in the first set of goods and services classifications 504A and/or the second set of goods and services classifications 504B satisfy the predetermined condition with the predetermined threshold, the method of flowchart 600C proceeds to step 610.

In step 608, goods and services similarity scores are determined for the highest ranking goods and services classifications. For example, score generator 502 and/or prediction model 124 may determine goods and services similarity scores for one or more pairs of goods and services classifications from the first set of goods and services classifications 504A and/or the second set of goods and services classifications 504B that satisfy the predetermined condition with the predetermined threshold (e.g., exceed the confidence probability threshold).

In step 610, goods and services similarity scores are determined for the most frequent goods and services classifications. For example, score generator 502 and/or prediction model 124 may determine goods and services similarity scores for one or more pairs of goods and services classifications from the first set of goods and services classifications 504A and/or the second set of goods and services classifications 504B that appear the highest number of times in the first set of goods and services classifications 504A and/or the second set of goods and services classifications 504B. For example, step 610 may be performed when no goods and services classifications have a confidence probability that exceeds the confidence probability threshold and/or at other times.

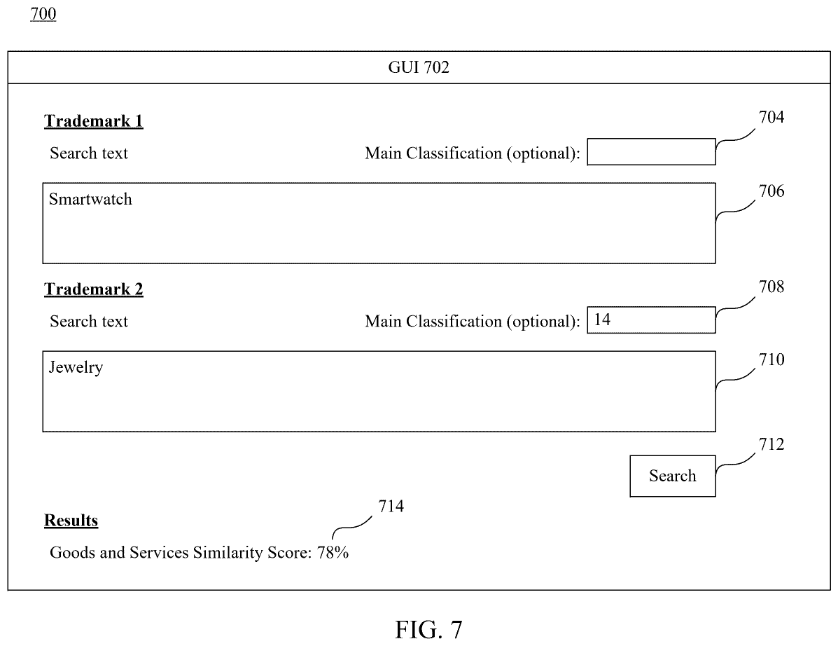

FIG. 7 shows an example user interface (UI) 700 via which a user may query the similarity between two goods and services descriptions. In an embodiment, UI 700 may be implemented by system 100, for example, as UI 110. Accordingly, GUI 700 will be described with continued reference to FIG. 1.

As shown in FIG. 7, GUI 700 may represent an example of UI 110. GUI 700 may include one or more window(s) 702. Window(s) 702 may include one or more input fields 704-710 for entering a query. For instance, a user may, optionally, employ input fields 704 and 708 to enter a main goods and services classification for a first trademark and a second trademark, respectively. As discussed above, if the user leaves either of these input fields blank, system 100 may determine the main goods and services classification through other means. The user may employ input fields 706 and 710 to enter a first goods and services description and a second goods and services description, respectively. In some embodiments, input fields 706 and 710 may accept input other than a textual description. For example, a user may enter an identifier of a registered trademark (e.g., serial number) or the actual trademark into input fields 706 and/or 710. System 100 may retrieve the goods and services description corresponding to the entered trademark by accessing one or more databases available to system 100. Window(s) 702 may further include a button 712 that allows the user to submit the query. Alternatively or additionally, the user may submit the query through other means, for example, pressing the “ENTER” key on the keyboard. Window(s) 702 may include a results section 714 that displays the result of the query, including a goods and services similarity score that indicates the likelihood that an adjudicator would find a likelihood of confusion between a trademark having the first goods and services description and a trademark having the second goods and services description. The elements of GUI 700 depicted in FIG. 7 are merely exemplary, and more or less elements may be included or excluded from GUI 700.

Embodiments described herein may operate in various ways to automatically initiate a trademark proceeding based on an aggregate goods and services similarity score. For instance, FIG. 8 depicts a flowchart 800 of a method for automatically initiating a trademark proceeding based on an aggregate goods and services similarity score, according to an embodiment. Flowchart 800 may be implemented by systems 100, 300, 500A, and/or 500B, for example. Accordingly, flowchart 800 is described herein with continued reference to FIGS. 1, 3, 5A, and 5B. The method of flowchart 800 starts at step 802.

In step 802, it is determined that an aggregate goods and services similarity score is greater than or equal to a first similarity threshold. For instance, query result generator 120 receives an aggregate goods and services similarity score from goods and services classification similarity score calculator 118 and determines that the aggregate goods and services similarity score exceeds a first predetermined similarity threshold. In embodiments, the first predetermined similarity threshold is a numerical (e.g., percentage, fraction, floating point number, etc.) that is configurable by a user. A determination that the aggregate goods and services similarity score exceeds the second predetermined similarity threshold indicates a threshold similarity between trademark classifications associated with a first goods and services description and a second goods and services description that will likely cause confusion between a first trademark associated with the first goods and services description and a second trademark associated with the second goods and services description.

In step 804, a trademark proceeding is automatically initiated. For instance, query result generator 120 automatically generates and/or files a trademark proceeding in a trademark jurisdiction. In embodiments, query result generator 120 automatically populates filing documents with the necessary information, such as, but not limited to, a conflicting trademark, a goods and services description associated with the conflicting trademark, a goods and services classification associated with the conflicting trademark, and/or the like. Query result generator 120 automatically generates and/or files documents for various trademark proceedings, such as, but not limited to, opposition proceedings to oppose the registration of a potentially conflicting trademark, a cancellation proceeding to cancel a conflicting trademark, a trademark infringement lawsuit against an infringing party associated with the conflicting trademark, and/or the like. In embodiments, query result generator 120 automatically files the trademark proceeding at the proper venue. In other embodiments, query result generator 120 provides the generated documents for review by a user (e.g., attorney) for filing at the proper venue.

Embodiments described herein may operate in various ways to automatically initiate the filing of a trademark application based on an aggregate goods and services similarity score. For instance, FIG. 9 depicts a flowchart 900 of a method for automatically initiating the filing of a trademark application based on an aggregate goods and services similarity score, in accordance with an embodiment. Flowchart 900 may be implemented by systems 100, 300, 500A, and/or 500B, for example. Accordingly, flowchart 900 is described with continued reference to FIGS. 1, 3, 5A, and 5B. The method of flowchart 900 starts at step 902.

In step 902, it is determined that an aggregate goods and services similarity score is less than or equal to a second similarity threshold. For instance, query result generator 120 receives an aggregate goods and services similarity score from goods and services classification similarity score calculator 119 and determines that the aggregate goods and services similarity score is less than or equal to a second predetermined similarity threshold. In embodiments, the second predetermined similarity threshold is a numerical (e.g., percentage, fraction, floating point number, etc.) that is configurable by a user. A determination that the aggregate goods and services similarity score is less than or equal to the second predetermined similarity threshold indicates a lack of a threshold similarity between trademark classifications associated with a first goods and services description and a second goods and services description that is unlikely to cause confusion between a first trademark associated with the first goods and services description and a second trademark associated with the second goods and services description. In embodiments, the second predetermined similarity threshold is the same as or different from the first predetermined similarity threshold discussed above in conjunction with FIG. 8.

In step 904, a trademark application is automatically initiated. For instance, query result generator 120 automatically generates and/or files a trademark application in a trademark jurisdiction. In embodiments, query result generator 120 automatically populates filing documents with the necessary information, such as, but not limited to, a trademark to be registered, a goods and services description associated with the trademark to be registered, a goods and services classification associated with the trademark to be registered, and/or the like. In embodiments, query result generator 120 automatically files the trademark application with the trademark office in the jurisdiction. In other embodiments, query result generator 120 provides the generated documents for review by a user (e.g., attorney) for filing with the trademark office in the jurisdiction.

### III. Example Mobile Device and Computer System Implementation

The systems and methods described above in reference to FIGS. 1-9, including client(s) 102, server(s) 104, historical trademark database(s) 106, network(s) 108, UI 110, goods and services classification similarity determiner 112, query processor 114, goods and services description classifier 116, goods and services classification similarity score calculator 118, query result generator 120, classification model(s) 122, prediction model 124, tokenizer 302, semantic analyzer 304, main classification determiner 306, score generator 504, model trainer 508, each of the components described therein, and/or the steps of flowcharts 200, 400A, 400B, 400C, 600A, 600B, 600C, and/or 1000, and/or GUI 700 may be implemented in hardware, or hardware combined with one or both of software and/or firmware. For example, client(s) 102, server(s) 104, historical trademark database(s) 106, network(s) 108, UI 110, goods and services classification similarity determiner 112, query processor 114, goods and services description classifier 116, goods and services classification similarity score calculator 118, query result generator 120, classification model(s) 122, prediction model 124, tokenizer 302, semantic analyzer 304, main classification determiner 306, score generator 504, model trainer 508, each of the components described therein, and/or the steps of flowcharts 200, 400A, 400B, 400C, 600A, 600B, 600C, and/or 1000, and/or GUI 700 may be each implemented as computer program code/instructions configured to be executed (e.g., computer-executable) in one or more processors and stored in a computer readable storage medium. Alternatively, client(s) 102, server(s) 104, historical trademark database(s) 106, network(s) 108, UI 110, goods and services classification similarity determiner 112, query processor 114, goods and services description classifier 116, goods and services classification similarity score calculator 118, query result generator 120, classification model(s) 122, prediction model 124, tokenizer 302, semantic analyzer 304, main classification determiner 306, score generator 504, model trainer 508, each of the components described therein, and/or the steps of flowcharts 200, 400A, 400B, 400C, 600A, 600B, 600C, and/or 1000, and/or GUI 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to cause a processor to perform functions.

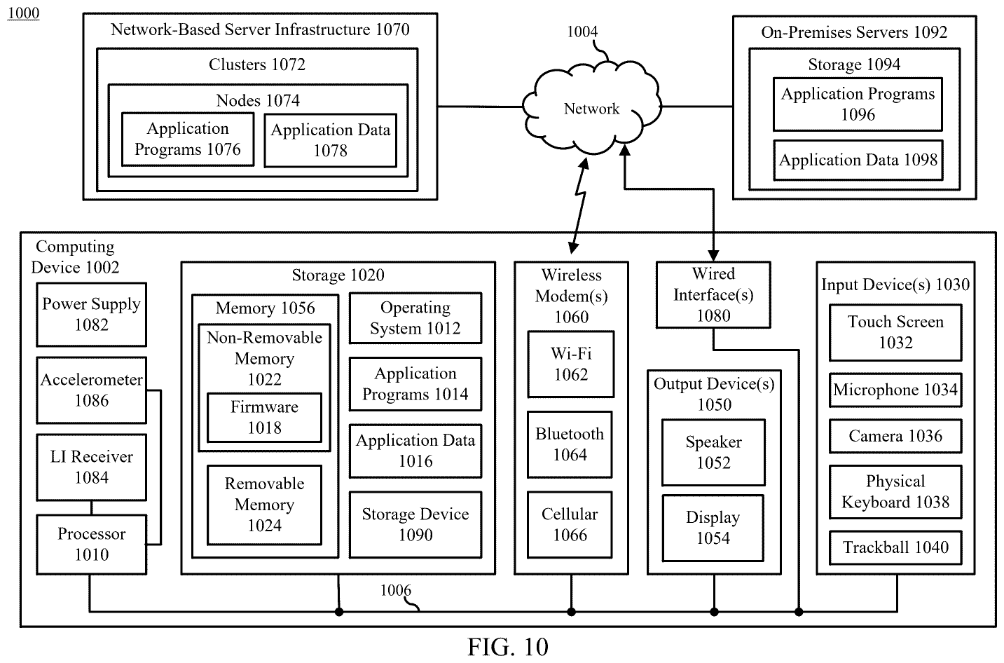

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 10. FIG. 10 shows a block diagram of an exemplary computing environment 1000 that includes a computing device 1002. In some embodiments, computing device 1002 is communicatively coupled with devices (not shown in FIG. 10) external to computing environment 1000 via network 1004. Network 1004 comprises one or more networks such as local area networks (LANs), wide area networks (WANs), enterprise networks, the Internet, etc., and may include one or more wired and/or wireless portions. Network 1004 may additionally or alternatively include a cellular network for cellular communications. Computing device 1002 is described in detail as follows

Computing device 1002 can be any of a variety of types of computing devices. For example, computing device 1002 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1002 may alternatively be a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, one or more input devices 1030, one or more output devices 1050, one or more wireless modems 1060, one or more wired interfaces 1080, a power supply 1082, a location information (LI) receiver 1084, and an accelerometer 1086. Storage 1020 includes memory 1056, which includes non-removable memory 1022 and removable memory 1024, and a storage device 1090. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1030 includes a touch screen 1032, a microphone 1034, a camera 1036, a physical keyboard 1038, and a trackball 1040. Not all components of computing device 1002 shown in FIG. 10 are present in all embodiments, additional components not shown may be present, and any combination of the components may be present in a particular embodiment. These components of computing device 1002 are described as follows.

A single processor 1010 (e.g., central processing unit (CPU), microcontroller, a microprocessor, signal processor, ASIC (application specific integrated circuit), and/or other physical hardware processor circuit) or multiple processors 1010 may be present in computing device 1002 for performing such tasks as program execution, signal coding, data processing, input/output processing, power control, and/or other functions. Processor 1010 may be a single-core or multi-core processor, and each processor core may be single-threaded or multithreaded (to provide multiple threads of execution concurrently). Processor 1010 is configured to execute program code stored in a computer readable medium, such as program code of operating system 1012 and application programs 1014 stored in storage 1020. Operating system 1012 controls the allocation and usage of the components of computing device 1002 and provides support for one or more application programs 1014 (also referred to as “applications” or “apps”). Application programs 1014 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1002 can communicate with any other component according to function, although not all connections are shown for ease of illustration. For instance, as shown in FIG. 10, bus 1006 is a multiple signal line communication medium (e.g., conductive traces in silicon, metal traces along a motherboard, wires, etc.) that may be present to communicatively couple processor 1010 to various other components of computing device 1002, although in other embodiments, an alternative bus, further buses, and/or one or more individual signal lines may be present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1090, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1022 may include main memory and may be separate from or fabricated in a same integrated circuit as processor 1010. As shown in FIG. 10, non-removable memory 1022 stores firmware 1018, which may be present to provide low-level control of hardware. Examples of firmware 1018 include BIOS (Basic Input/Output System, such as on personal computers) and boot firmware (e.g., on smart phones). Removable memory 1024 may be inserted into a receptacle of or otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1090 may be present that are internal and/or external to a housing of computing device 1002 and may or may not be removable. Examples of storage device 1090 include a hard disk drive, a SSD, a thumb drive (e.g., a USB (Universal Serial Bus) flash drive), or other physical storage device.

One or more programs may be stored in storage 1020. Such programs include operating system 1012, one or more application programs 1014, and other program modules and program data. Examples of such application programs may include, for example, computer program logic (e.g., computer program code/instructions) for implementing one or more of client(s) 102, server(s) 104, historical trademark database(s) 106, network(s) 108, UI 110, goods and services classification similarity determiner 112, query processor 114, goods and services description classifier 116, goods and services classification similarity score calculator 118, query result generator 120, classification model(s) 122, prediction model 124, tokenizer 302, semantic analyzer 304, main classification determiner 306, score generator 504, model trainer 508, and/or each of the components described therein, along with any components and/or subcomponents thereof, as well as the flowcharts/flow diagrams (e.g., flowcharts 200, 400A, 400B, 400C, 600A, 600B, 600C, and/or 1000) described herein, including portions thereof, and/or user interfaces (e.g., GUI 700) described herein, including portions thereof, and/or further examples described herein.

Storage 1020 also stores data used and/or generated by operating system 1012 and application programs 1014 as application data 1016. Examples of application data 1016 include web pages, text, images, tables, sound files, video data, and other data, which may also be sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1002 through one or more input devices 1030 and may receive information from computing device 1002 through one or more output devices 1050. Input device(s) 1030 may include one or more of touch screen 1032, microphone 1034, camera 1036, physical keyboard 1038 and/or trackball 1040 and output device(s) 1050 may include one or more of speaker 1052 and display 1054. Each of input device(s) 1030 and output device(s) 1050 may be integral to computing device 1002 (e.g., built into a housing of computing device 1002) or external to computing device 1002 (e.g., communicatively coupled wired or wirelessly to computing device 1002 via wired interface(s) 1080 and/or wireless modem(s) 1060). Further input devices 1030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 may display information, as well as operating as touch screen 1032 by receiving user commands and/or other information (e.g., by touch, finger gestures, virtual keyboard, etc.) as a user interface. Any number of each type of input device(s) 1030 and output device(s) 1050 may be present, including multiple microphones 1034, multiple cameras 1036, multiple speakers 1052, and/or multiple displays 1054.

One or more wireless modems 1060 can be coupled to antenna(s) (not shown) of computing device 1002 and can support two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). Wireless modem 1060 may also or alternatively include other radio-based modem types, such as a Bluetooth modem 1064 (also referred to as a “Bluetooth device”) and/or Wi-Fi modem 1062 (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 1002.11 family of standards, commonly used for local area networking of devices and Internet access. Bluetooth modem 1064 is configured to communicate with another Bluetooth-capable device according to the Bluetooth short-range wireless technology standard(s) such as IEEE 1002.15.1 and/or managed by the Bluetooth Special Interest Group (SIG).

Computing device 1002 can further include power supply 1082, LI receiver 1084, accelerometer 1086, and/or one or more wired interfaces 1080. Example wired interfaces 1080 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1080 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1036, physical keyboard 1038, etc.). Power supply 1082 is configured to supply power to each of the components of computing device 1002 and may receive power from a battery internal to computing device 1002, and/or from a power cord plugged into a power port of computing device 1002 (e.g., a USB port, an A/C power port). LI receiver 1084 may be used for location determination of computing device 1002 and may include a satellite navigation receiver such as a Global Positioning System (GPS) receiver or may include other type of location determiner configured to determine location of computing device 1002 based on received information (e.g., using cell tower triangulation, etc.). Accelerometer 1086 may be present to determine an orientation of computing device 1002.

Note that the illustrated components of computing device 1002 are not required or all-inclusive, and fewer or greater numbers of components may be present as would be recognized by one skilled in the art. For example, computing device 1002 may also include one or more of a gyroscope, barometer, proximity sensor, ambient light sensor, digital compass, etc. Processor 1010 and memory 1056 may be co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein may be stored in storage 1020 and executed by processor 1010.

In some embodiments, server infrastructure 1070 may be present in computing environment 1000 and may be communicatively coupled with computing device 1002 via network 1004. Server infrastructure 1070, when present, may be a network-accessible server set (e.g., a cloud-based environment or platform). As shown in FIG. 10, server infrastructure 1070 includes clusters 1072. Each of clusters 1072 may comprise a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. Any of nodes 1074 may be a storage node that comprises a plurality of physical storage disks, SSDs, and/or other physical storage devices that are accessible via network 1004 and are configured to store data associated with the applications and services managed by nodes 1074. For example, as shown in FIG. 10, nodes 1074 may store application data 1078.

Each of nodes 1074 may, as a compute node, comprise one or more server computers, server systems, and/or computing devices. For instance, a node 1074 may include one or more of the components of computing device 1002 disclosed herein. Each of nodes 1074 may be configured to execute one or more software applications (or “applications”) and/or services and/or manage hardware resources (e.g., processors, memory, etc.), which may be utilized by users (e.g., customers) of the network-accessible server set. For example, as shown in FIG. 10, nodes 1074 may operate application programs 1076. In an implementation, a node of nodes 1074 may operate or comprise one or more virtual machines, with each virtual machine emulating a system architecture (e.g., an operating system), in an isolated manner, upon which applications such as application programs 1076 may be executed.

In an embodiment, one or more of clusters 1072 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1072 may be a datacenter in a distributed collection of datacenters. In embodiments, exemplary computing environment 1000 comprises part of a cloud-based platform such as Amazon Web Services® of Amazon Web Services, Inc. or Google Cloud Platform™ of Google LLC, although these are only examples and are not intended to be limiting.

In an embodiment, computing device 1002 may access application programs 1076 for execution in any manner, such as by a client application and/or a browser at computing device 1002. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1002 may additionally and/or alternatively synchronize copies of application programs 1014 and/or application data 1016 to be stored at network-based server infrastructure 1070 as application programs 1076 and/or application data 1078. For instance, operating system 1012 and/or application programs 1014 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1020 at network-based server infrastructure 1070.

In some embodiments, on-premises servers 1092 may be present in computing environment 1000 and may be communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 may be shared by on-premises servers 1092 between computing devices of the organization, including computing device 1002 (when part of an organization) through a local network of the organization, and/or through further networks accessible to the organization (including the Internet). Furthermore, on-premises servers 1092 may serve applications such as application programs 1096 to the computing devices of the organization, including computing device 1002. Accordingly, on-premises servers 1092 may include storage 1094 (which includes one or more physical storage devices such as storage disks and/or SSDs) for storage of application programs 1096 and application data 1098 and may include one or more processors for execution of application programs 1096. Still further, computing device 1002 may be configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 may be used to implement systems, clients, or devices, or components/subcomponents thereof, disclosed elsewhere herein. In other embodiments, a combination of computing device 1002, network-based server infrastructure 1070, and/or on-premises servers 1092 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1014) may be stored in storage 1020. Such computer programs may also be received via wired interface(s) 1080 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### IV. CONCLUSION

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined in accordance with the following claims and their equivalents.

What is claimed is:

1. A method for determining a similarity between goods and services, comprising:
receiving a query including a first goods and services description and a second goods and services description;
providing the first goods and services description and the second goods and services description to a first machine learning model;
receiving, from the first machine learning model, a first set of goods and services classifications for the first goods and services description and a second set of goods and services classifications for the second goods and services description;
determining a plurality of goods and services similarity scores, each goods and services similarity score of the determined plurality of goods and services similarity scores indicating a similarity between a first goods and services classification from the first set of goods and services classifications and a second goods and services classification from the second set of goods and services classifications;
determining an aggregate goods and services similarity score based on the determined plurality of goods and services similarity scores; and
providing the aggregate goods and services similarity score as a query result.

2. The method of claim 1, wherein said determining the plurality of goods and services similarity scores comprises:
determining a goods and services similarity score based on a proportion of historical trademark cases where a similarity assessment has determined that the first goods and services classification related to a first trademark is similar to the second goods and services classification related to a second trademark.

3. The method of claim 1, wherein said determining the plurality of goods and services similarity scores comprises:
determining a goods and services similarity score using a machine learning prediction model that is trained using data from historical trademark cases where a similarity assessment has been performed.

4. The method of any of claim 1, further comprising:
determining a first set of text fragments that are semantically similar to the first goods and services description and a second set of text fragments that are semantically similar to the second goods and services description; and
providing the first set of text fragments and the second set of text fragments to the first machine learning model;
wherein the first machine learning model:
determines the first set of goods and services classifications based on the first goods and services description and the first set of text fragments, and
determines the second set of goods and services classifications based on the second goods and services description and the second set of text fragments.

5. The method of claim 4, further comprising:
providing the first goods and services description and the first set of text fragments to a second machine learning model;
receiving, from the second machine learning model, a third set of goods and services classifications determined based on the first goods and services description and the first set of text fragments; and
ranking the goods and services classifications from the first set of goods and services classifications and the third set of goods and services classifications based on a confidence probability associated with each of the goods and services classifications from the first set of goods and services classifications and the third set of goods and services classifications,
wherein said determining a plurality of goods and services similarity scores comprises:
determining goods and services similarity scores for highest ranking goods and services classifications having confidence probabilities that exceed a confidence probability threshold; or
determining goods and services similarity scores for the goods and services classifications that appear most frequently when no goods and services classification have a confidence probability that exceeds the confidence probability threshold.

6. The method of any of claim 1, further comprising:
determining a main goods and services classification associated with the first goods and services description, wherein the first set of goods and services classifications provided by the first machine learning model include sub-classifications of the main goods and services classification.

7. The method of any of claim 1, wherein the first set of goods and services classifications or the second set of goods and services classifications include Nice Classification (NCL) classifications and/or sub-classifications.

8. A system for determining a similarity between goods and services, comprising:
a processor; and
a computer-readable medium comprising computer-executable instructions, that when executed by the processor, causes the processor to:
receive a query including a first goods and services description and a second goods and services description;
provide the first goods and services description and the second goods and services description to a first machine learning model;
receive, from the first machine learning model, a first set of goods and services classifications for the first goods and services description and a second set of goods and services classifications for the second goods and services description;
determine a plurality of goods and services similarity scores, each goods and services similarity score of the determined plurality of goods and services similarity scores indicating a similarity between a first goods and services classification from the first set of goods and services classifications and a second goods and services classification from the second set of goods and services classifications;
determine an aggregate goods and services similarity score based on the determined plurality of goods and services similarity scores; and
provide the aggregate goods and services similarity score as a query result.

9. The system of claim 8, wherein said determining the plurality of goods and services similarity scores comprises:
determining a goods and services similarity score based on a proportion of historical trademark cases where a similarity assessment has determined that the first goods and services classification related to a first trademark is similar to the second goods and services classification related to a second trademark.

10. The system of claim 8, wherein said determining the plurality of goods and services similarity scores comprises:
determining a goods and services similarity score using a machine learning prediction model that is trained using data from historical trademark cases where a similarity assessment has been performed.

11. The system of any of claim 8, wherein the instructions, when executed by the processor, further cause the processor to:
determine a first set of text fragments that are semantically similar to the first goods and services description and a second set of text fragments that are semantically similar to the second goods and services description; and
provide the first set of and the second set of text fragments to the first machine learning model,
wherein the first machine learning model:
determines the first set of goods and services classifications based on the first goods and services description and the first set of text fragments, and
determines the second set of goods and services classifications based on the second goods and services description and the second set of text fragments.

12. The system of claim 11, wherein the instructions, when executed by the processor, further cause the processor to:
provide the first goods and services description and the first set of text fragments to a second machine learning model;
receive, from the second machine learning model, a third set of goods and services classifications determined based on the first goods and services description and the first set of text fragments; and
rank the goods and services classifications from the first set of goods and services classifications and the third set of goods and services classifications based on a confidence probability associated with each of the goods and services classifications from the first set of goods and services classifications and the third set of goods and services classifications,
wherein said determining a plurality of goods and services similarity scores comprises:
determining goods and services similarity scores for highest ranking goods and services classifications having confidence probabilities that exceed a confidence probability threshold; or
determining goods and services similarity scores for the goods and services classifications that appear most frequently when no goods and services classification have a confidence probability that exceeds the confidence probability threshold.

13. The system of any of claim 8, wherein the instructions, when executed by the processor, further cause the processor to:
determine a main goods and services classification associated with the first goods and services description, wherein the first set of goods and services classifications provided by the first machine learning model include sub-classifications of the main goods and services classification.

14. The system of any of claim 8, wherein the first set of goods and services classifications or the second set of goods and services classifications include Nice Classification (NCL) classifications and/or sub-classifications.

15. A computer-readable medium comprising computer-executable instructions, that when executed by a processor, causes the processor to:
receive a query including a first goods and services description and a second goods and services description;
provide the first goods and services description and the second goods and services description to a first machine learning model;
receive, from the first machine learning model, a first set of goods and services classifications for the first goods and services description and a second set of goods and services classifications for the second goods and services description;
determine a plurality of goods and services similarity scores, each goods and services similarity score of the determined plurality of goods and services similarity scores indicating a similarity between a first goods and services classification from the first set of goods and services classifications and a second goods and services classification from the second set of goods and services classifications;
determine an aggregate goods and services similarity score based on the determined plurality of goods and services similarity scores; and
provide the aggregate goods and services similarity score as a query result.

16. The computer-readable medium of claim 15, wherein said determining the plurality of goods and services similarity scores comprises:
determining a goods and services similarity score based on a proportion of historical trademark cases where a similarity assessment has determined that the first goods and services classification related to a first trademark is similar to the second goods and services classification related to a second trademark.

17. The computer-readable medium of claim 15, wherein said determining the plurality of goods and services similarity scores comprises:
determining a goods and services similarity score using a machine learning prediction model that is trained using data from historical trademark cases where a similarity assessment has been performed.

18. The computer-readable medium of any of claim 15, wherein the instructions, when executed by the processor, further cause the processor to:
determine a first set of text fragments that are semantically similar to the first goods and services description and a second set of text fragments that are semantically similar to the second goods and services description; and
provide the first set of text fragments and the second set of text fragments to the first machine learning model,
wherein the first machine learning model:
determines the first set of goods and services classifications based on the first goods and services description and the first set of text fragments, and
determines the second set of goods and services classifications based on the second goods and services description and the second set of text fragments.

19. The computer-readable medium of claim 18, wherein the instructions, when executed by the processor, further cause the processor to:
provide the first goods and services description and the first set of text fragments to a second machine learning model;
receive, from the second machine learning model, a third set of goods and services classifications determined based on the first goods and services description and the first set of text fragments; and
rank the goods and services classifications from the first set of goods and services classifications and the third set of goods and services classifications based on a confidence probability associated with each of the goods and services classifications from the first set of goods and services classifications and the third set of goods and services classifications,
wherein said determining a plurality of goods and services similarity scores comprises:
determining goods and services similarity scores for highest ranking goods and services classifications having confidence probabilities that exceed a confidence probability threshold; or
determining goods and services similarity scores for the goods and services classifications that appear most frequently when no goods and services classification have a confidence probability that exceeds the confidence probability threshold.

20. The computer-readable medium of any of claim 15, wherein the first set of goods and services classifications or the second set of goods and services classifications include Nice Classification (NCL) classifications and/or sub-classifications.
